(19) United States
(12) Patent Application Publication
(10) Pub. No.: US 2011/0210278 A1
(43) Pub. Date: Sep. 1, 2011

(54) VALVE FOR UNIVERSAL UTILIZATION AND SEVERAL PURPOSES

(76) Inventors: Gabor Horvath, Budapest (HU); Attila Kovacs, Budapest (HU); Gyula Satori, Erd (HU)

(21) Appl. No.: 13/127,305

(22) PCT Filed: Nov. 3, 2009
(86) PCT No.: PCT/HU09/00089

§ 371 Date: May 3, 2011

(30) Foreign Application Priority Data
Nov. 4, 2008 (HU) P 08 00613
Nov. 24, 2008 (HU) P 08 00715
Aug. 11, 2009 (HU) P 09 00501

(51) Int. Cl. F16K 13/00

(52) U.S. Cl. 251/356

(57) ABSTRACT

The subject of the invention is a valve for universal utilization and several purposes allowing by its formation the relatively high flow in the basic state and slightly open state of the valve even in case of small pressure differences in case of low pressure; furthermore the formation of the valve allows to ensure providing functions depending on the direction of flow that in given case can be regulated regarding back-pressure, partial back-pressure, pressure relief, partial relief limiting functions.

The valve according to the invention is made in one piece from a soft, flexible material, and it has a full cross-sectional open basic part (2) at one end, and an intermediate part (3) of decreasing cross-section joining the said basic part (2), as well as a flattened part (4) joining the intermediate part (3) in the other end of the valve (1). It is characterized by that, the flattened part (4) is a structure sintered or pressed or glued in the material of the valve (1), and on the flattened part (4) of the valve (1) a pressed rim (7) made by airtight fixing of the edges of the flattened part (4), preferably by sintering, or pressing or glueing is formed, furthermore the length (L) of the intermediate part (3) is L=0,5 . . . (K/π), compared to perimeter (K) in the basic part of the valve (1), in connection with the medium in motion, and the length (N) of the pressed rim (7) in the basic part of the valve (1) compared to perimeter (K) in connection with the medium in motion is N=0,1 . . . 2 (K/π).

The subject of the invention is a valve for universal utilization and several purposes allowing by its formation the relatively high flow in the basic state and slightly open state of the valve even in case of small pressure differences in case of low pressure; furthermore the formation of the valve allows to ensure providing functions depending on the direction of flow that in given case can be regulated regarding back-pressure, partial back-pressure, pressure relief, partial pressure relief functions.

In everyday life there are several types of valves used. One of the big groups of valves is the valves of universal utilization, and several purposes, in given case non-return and pressure relief valves ensuring the flow of material between two spaces of different pressure, so that when different pressure occurs, the given medium in motion flows from the space of higher pressure to the space of lower pressure. The main function of check valves is to ensure the flow of the material into one direction only, that is from the space of higher pressure towards the space of lower pressure and to prevent the flow back.

One of the problems in using check valves is, that a certain force is needed for the proper closing of the check valve, which is ensured in case of certain solutions by the pressure of the flowing back medium in motion itself. In case of other solutions the closing force is achieved, respectively increased by an external effect, eg. with the help of a spring or magnet. The check valves are mainly such structures, which can be used in case of greater pressure differences. Resulting from the structure most of the check valves are not suitable for quick closing, respectively for the speed of closing required by the application in case of small pressure differences, respectively for the quick prevention of back flow.

In the state of the art the FR 2 756 899 patent application published on Dec. 6, 1998 makes known a valve of instant closing, as well as a feeder provided with a pump with this valve. The valve is one-way and closes within a minute. An ingoing tube, an outgoing opening and an opening/closing device bordered by two surfaces situated on each other belong to the valve. The two surfaces are connected to each other along two connecting lines, strictly on one plane. The opening/closing device has two ends. The ingoing tube is connected to the opening/closing device next to one end. The other end of the opening/closing device forms the outgoing opening. This way the outgoing opening/closing device can change from an open state—when resulting from the flowing material the two surfaces shove off between the two connecting lines, forming a channel this way, through which the flowing material can be fed through the outgoing opening—to a closed state—where resulting from the decrease of pressure from the side of the ingoing tube towards the outgoing opening, the surfaces fit to each other airtight. The opening/closing device is made of flexible material, which strictly can not be flexibly deformed. The connecting lines can move in the mentioned plane. The opening (respectively closing) of the opening/closing device take place basically by the approaching (respectively shoving out) of the connecting lines.

The U.S. Pat. No. 4,012,041 patent description makes known such a floatable ball, which has an outer shell made of rubber or rubber-like plastic enclosing an internal hollow space and a self-closing check valve runs through the shell. The check valve is cast from soft rubber and it has a pair of thin brink or rim with one or more openings situated next to each other, which open to let the air flow freely into the ball in case the pressure of the air on the external side of the valve is higher, than the pressure inside the ball. The hand pump has a nozzle fitting into the outer opening of the check valve, and the ball can be blown with air to the required pressure through this. The thin rims of the check valve close tightly to each other resulting from the pressure in the ball, making the opening of the valve close, so preventing the outflow of the air. Tennis balls having lost their pressure can be renewed in such a way, that a hole is bored into one side, a check valve is fixed by an adhesive to its sides, and when the adhesive is set, the ball is blown to the same pressure as in the new ball by a hand pump.

The DE GM 77 11 341 utility model description makes known a pump of small size with pump cylinder, which is primarily suitable for spraying fluids. The ingoing and outgoing openings of the pump are closed by a check valve provided with a pump-bucket in which a pump-bucket with bucket extension is wedged. Both of them are pierced through lengthwise, the bucket can be turned against the spring force, and the bucket extension is embedded into a spraying head. Both check valves are lip valves, the lips of which lie in an acute angle on each other shaping a gap. One of the lip valves turns with its lips toward the internal side of the cylinder at the ingoing opening of the pump cylinder, whereas a second lip valve turns with its lips toward the bore of the bucket extension, at the endface of the work. There is a compression lock between the two lip valves.

The KR 2005 0023666 patent application published on Mar. 10, 2005 makes known an elastic check valve. The valve has a valve body made of natural or synthetic rubber containing a core made of metal for reinforcing the valve body, built into the valve body. Furthermore a fixing unit belongs to the valve, which connects the reinforcing unit of the valve to a tube ensuring watertightness. The valve body has a fixing part with rim, an elastic opening-, and closing part, and the elastic opening-, and closing parts are formed as the extension of the fixing part with rim.

The drawbacks of the solutions above mentioned and used in practice are, that they can be primarily applied in case of great difference of pressure. The structure, that works well in case of great pressure differences, can not be efficiently applied in case of small pressure differences, by reason of the setting in pressure loss, or does not function at all. Further disadvantage is, that they are capable of pressure relief only in their closed state, but in a slightly open state they are not capable of functioning as a check valve, i.e. to prevent back flow.

In the state of the art in case of the blowing check valves applied currently, the valve is intentionally in closed position in basic state using the elastic property of the valve material. In case of these solutions the open position of the valve at any level causes the inoperativity of the valve, that is in case of opposite direction flow the valve does not close. It results from the fact, that to place the space to be closed under pressure, temporarily a structure opening the closing surfaces of the valve by force should be put in, eg. a pump-end, and we speak about relatively big pressure differences. There is not a demand in case of such solutions to fill in the closed space even in case of a pressure difference near zero, in order to retrieve the geometrical measurements of volume. So it is not obvious, that a structure meant to function as a check valve should be open in basic position. The practice requires, that it should be closed.

When working out the solution according to the invention we aimed to create a valve of univerzal utilization, of several purposes, allowing to ensure a relatively great flow in case of small pressure differences in case of low pressure, with low or near zero flow loss, great accuracy of repetition, furthermore the above functions can work starting from slightly open position of the valve in such a way, that depending on the direction of flow, functions regarding back-pressure, partial back-pressure, pressure relief and partial pressure relief functions can be ensured in given case in a way that can be regulated.

When creating the solution according to the invention, we realized, that in case we form a valve made of soft, elastic material in one piece, and with a basic part at one end in full cross-section open, and with an intermediate part with decreasing cross-section joining it, and in the other end of the valve a valve having a flattened part joining the intermediate part is formed, the flattened part of which is a sintered or pressed or glued structure in the material of the valve, and on the flattened part of the valve a pressed rim made by airtight fixing, preferably by sintering, or pressing or glueing of the edges of the flattened part is formed, furthermore the L length of the intermediate part is L=0, 5 . . . 6 (K/π), compared to K perimeter in the basic part of the valve, in connection with the flowing material, and the length N of the pressed rim in the basic part of the valve is N=0, 1 . . . 2 (K/π) compared to K perimeter in the basic part of the valve, contacted with the medium in motion, then the set aim can be achieved.

The invention is a valve for universal utilization and several purposes, said valve is made in one piece from a soft, flexible material, and it has a full cross-sectional open basic part at one end, and an intermediate part of decreasing cross-section joining the said basic part, as well as a flattened part joining the intermediate part in the other end of the valve, which is characterized by that, the flattened part is a structure sintered or pressed or glued in the material of the valve, and on the flattened part of the valve a pressed rim made by airtight fixing of the edges of the flattened part, preferably by sintering, or pressing or glueing is formed, furthermore the length (L) of the intermediate part is L=0, 5 . . . 6 (K/π), compared to perimeter (K) in the basic part of the valve, in connection with the medium in motion, and the length (N) of the pressed rim in the basic part of the valve compared to perimeter (K) in connection with the medium in motion is N=0, 1 . . . 2 (K/π).

In one preferred embodiment of the solution according to the invention, the shape of the open basic part of the valve is circular, or oval, or angular, in given case triangular, square or polygonal, in given case hexagonal, or octagonal.

In another preferred embodiment of the solution according to the invention, the flattened part is closed, or partly open in the basic state of the valve.

In a further preferred embodiment of the solution according to the invention, for influencing the closing of valve in given case magnetizable metal plates or magnet plates are placed on the flattened part of the valve, and/or the material of the flattened part can be magnetized in such a way, that in given case metal powder or magnetic powder is cast, or pressed or mixed into its material.

In a further preferred embodiment of the solution according to the invention, for influencing the closing of the valve in given case one or more expanded elastic fibres are symmetrically, or asymmetrically placed above the flattened part of the valve.

In a further preferred embodiment of the solution according to the invention, the material of said valve is of closed surface, preferably natural or artificial rubber, in given case silicone rubber, or textile or paper, impregnated or surface-treated by such material and the thickness (V) of the material of the valve compared to the perimeter (K) in the basic part of the valve in connection with the medium in motion is V=0, 01 . . . 0, 2 (K/π).

In a further preferred embodiment of the solution according to the invention, the material of the valve is porous material, preferably textile or paper and the rate of porousness compared to the free outflow is 2 . . . 40% surface proportionately.

In a further preferred embodiment of the solution according to the invention, the intermediate part of the valve is provided with flow gaps.

In a further preferred embodiment of the solution according to the invention, the valve in basic state is partly open, and the flow cross-section of the flattened part in basic state is 1 . . . 66% of the flow cross-section of the basic part.

In a further preferred embodiment of the solution according to the invention, the width (S) of the pressed rim compared to the perimeter (K) in connection with the medium in motion in the basic part of the valve is S=0, 04 . . . 0, 42 (K/π).

In a further preferred embodiment of the solution according to the invention, the valve is provided with a filter at its ingoing opening and/or at its outgoing opening.

In a further preferred embodiment of the solution according to the invention, the regulation of the closing of the valve takes place by the changing of the magnetic force.

The solution according to the invention is furthermore set forth by the enclosed drawings:

The FIG. 1 shows a possible realization of the valve according to the invention in closed state, in side view.

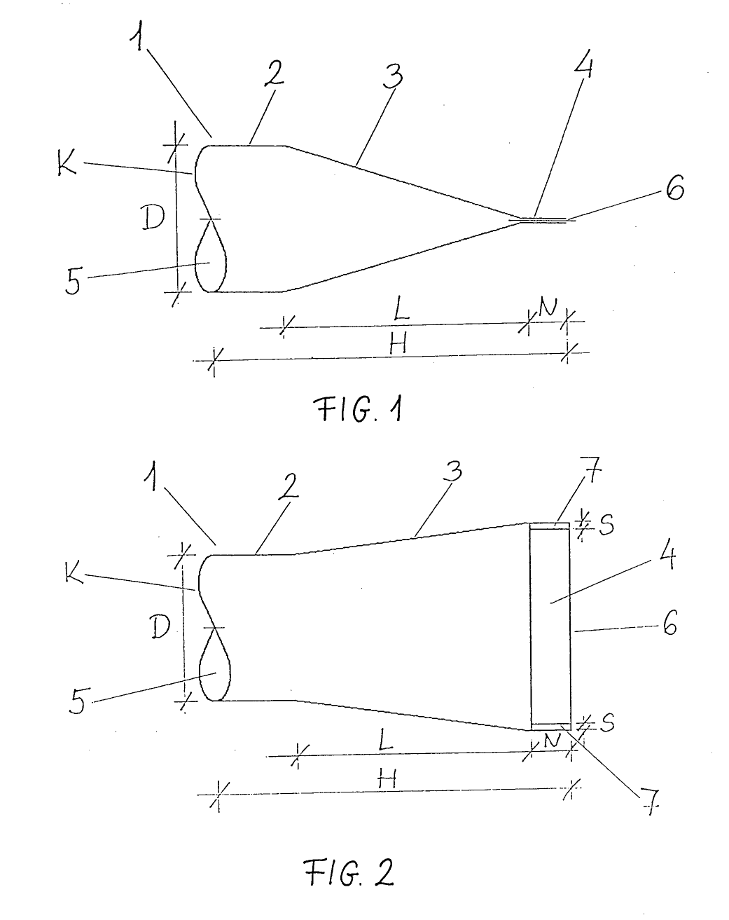

The FIG. 2 shows the realization of the valve according to the invention according to the FIG. 1, in top view.

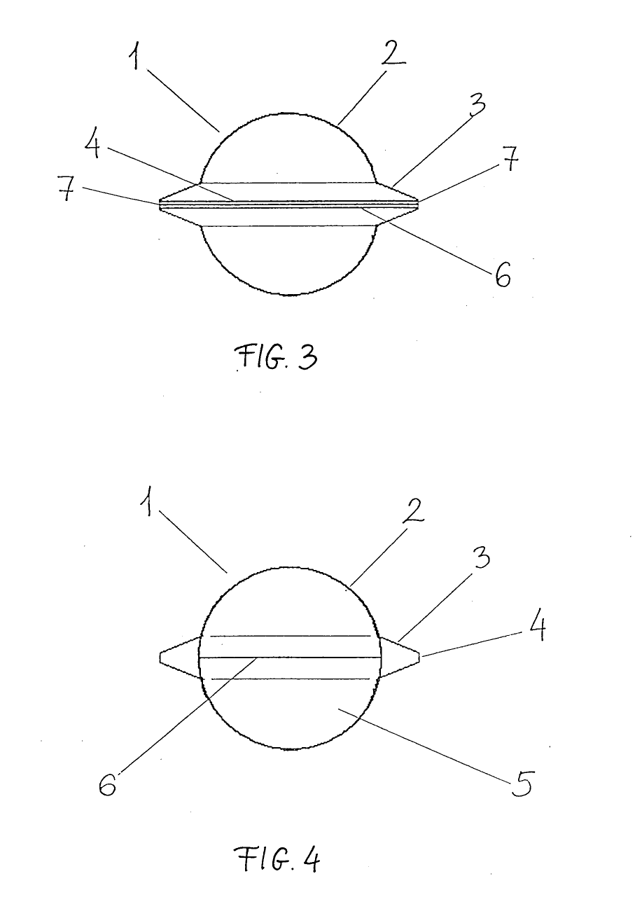

The FIG. 3 shows the realization of the valve according to the invention according to the FIG. 1, from its outgoing opening.

The FIG. 4 shows the realization of the valve according to the invention according to the FIG. 1, from its ingoing opening.

The FIG. 5 shows the realization of the valve according to the invention according to the FIG. 1, in slightly open position, in side view.

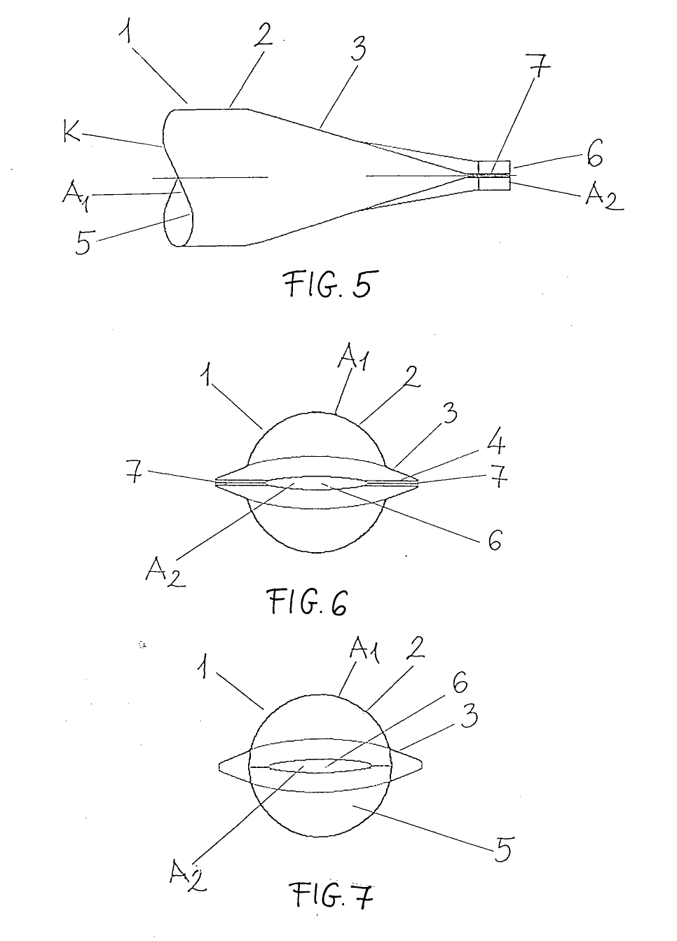

The FIG. 6 shows the realization of the valve according to the invention according to the FIG. 5, from its outgoing opening.

The FIG. 7 shows the realization of the valve according to the invention according to the FIG. 5, from its ingoing opening.

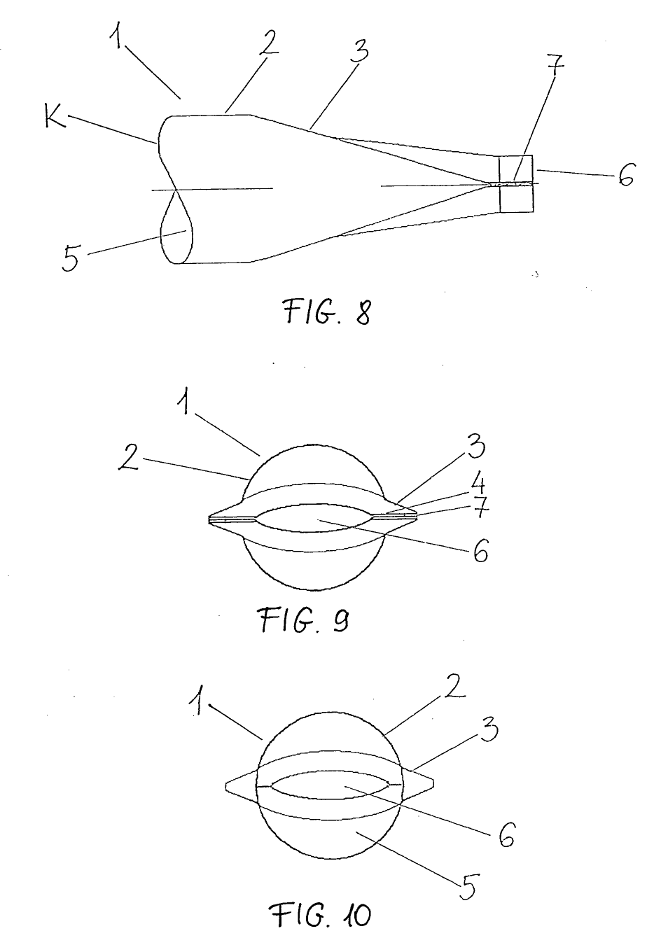

The FIG. 8 shows the realization of the valve according to the invention according to the FIG. 1, in completely open state, in side view.

The FIG. 9 shows the realization of the valve according to the invention according to the FIG. 8, from its ingoing opening.

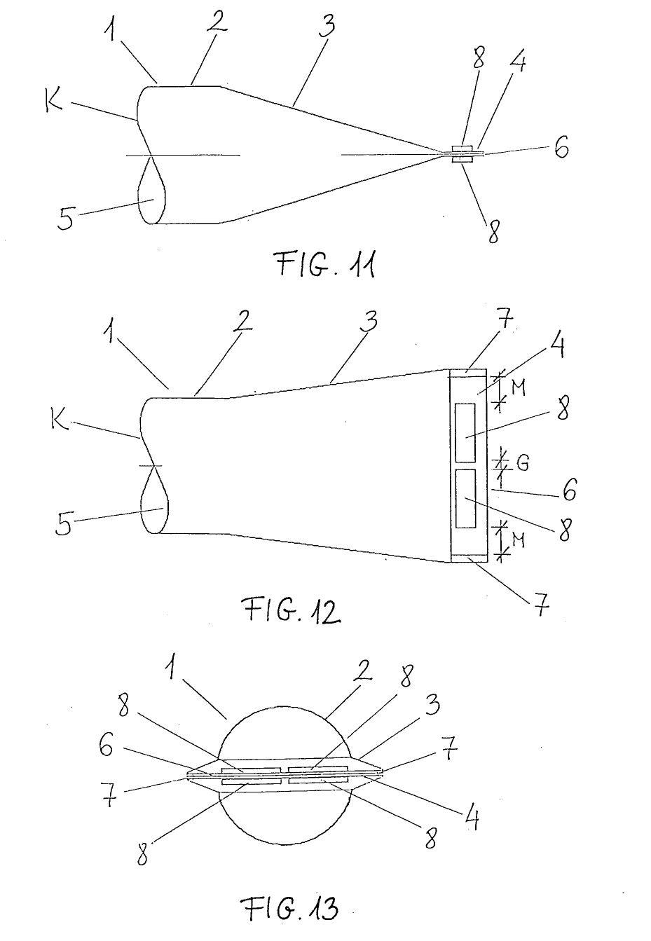

The FIG. 10 shows the realization of the valve according to the invention according to the FIG. 8, from its outgoing opening.

The FIG. 11 shows another possible realization of the valve according to the invention with the magnetic sheets placed on the flattened part, in side view.

The FIG. 12 shows the realization of the valve according to the invention according to the FIG. 11, in top view.

The FIG. 13 shows the realization of the valve according to the invention according to the FIG. 11, from its outgoing opening.

The FIG. 14 shows a further possible realization of the valve according to the invention according to the FIG. 11 in case of the expanded elastic fibre led above the flattened part, in side view.

The FIG. 15 shows the realization of the valve according to the invention according to the FIG. 14, in top view.

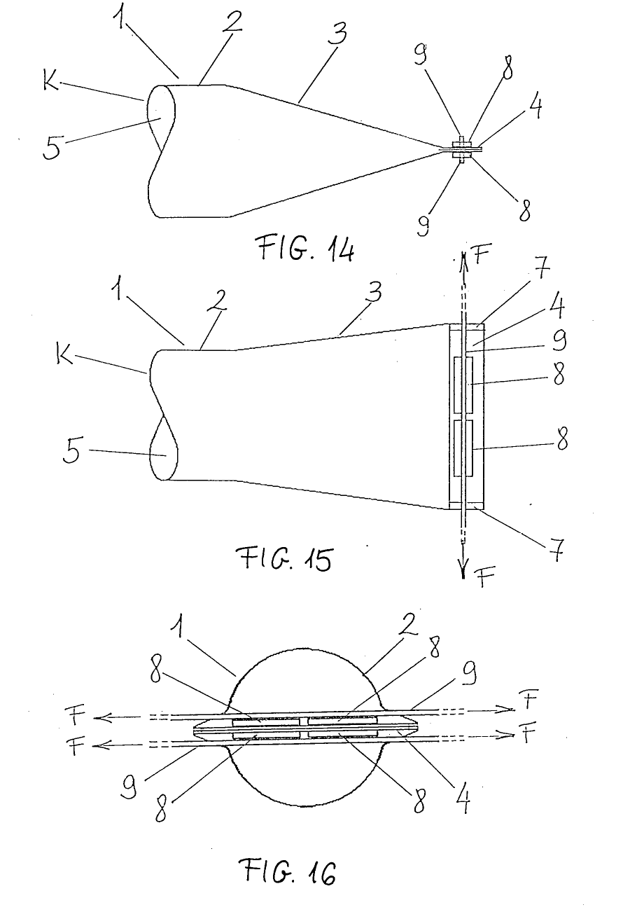

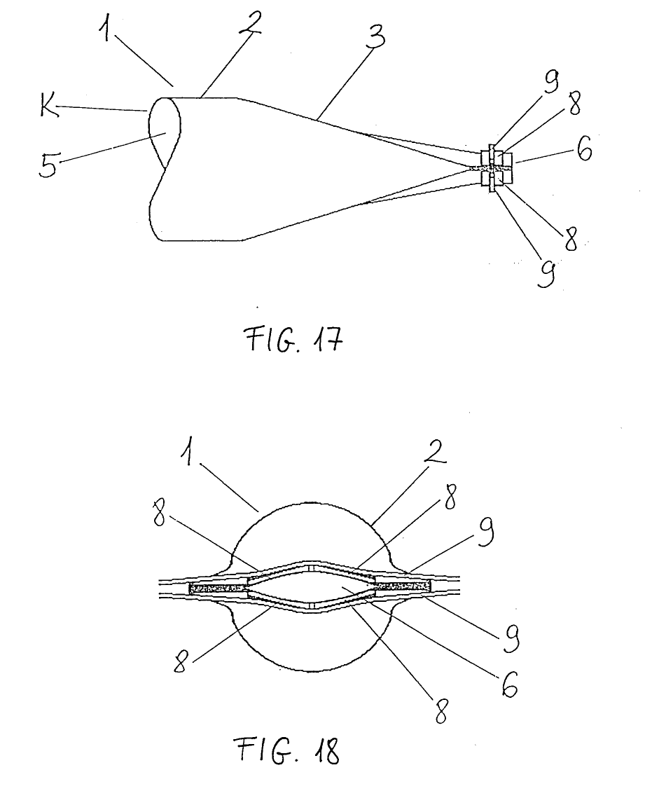

The FIG. 16 shows the realization of the valve according to the invention according to the FIG. 14, from its outgoing opening.

The FIG. 17 shows the realization of the valve according to the invention according to the FIG. 14, in open position, in side view.

The FIG. 18 shows the realization of the valve according to the invention according to the FIG. 14, in open position, from its outgoing opening.

The FIG. 19 shows a further possible realization of the valve according to the invention, in closed position, in semi-view, semi-section.

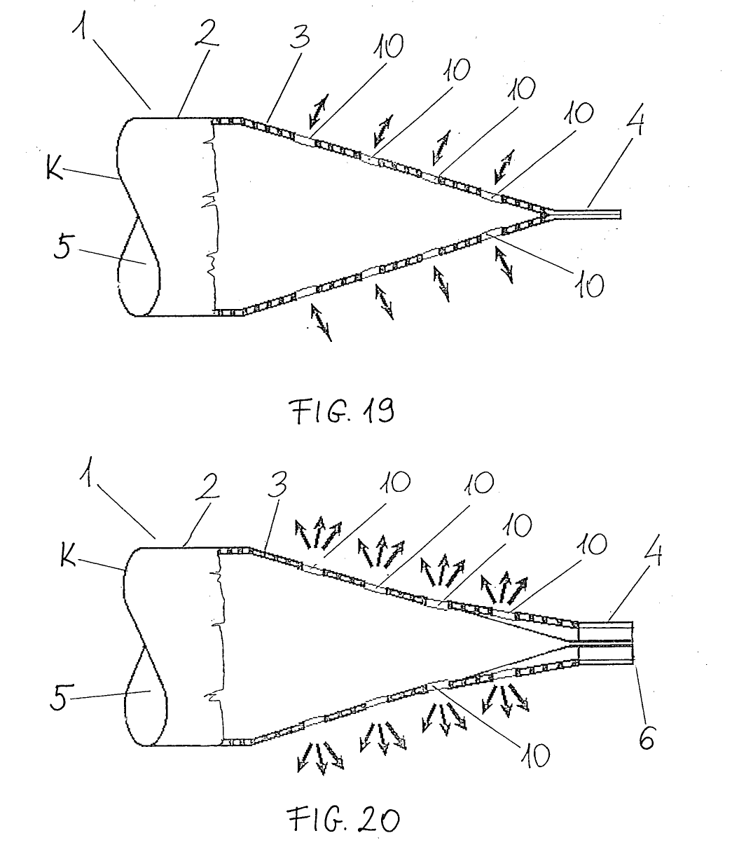

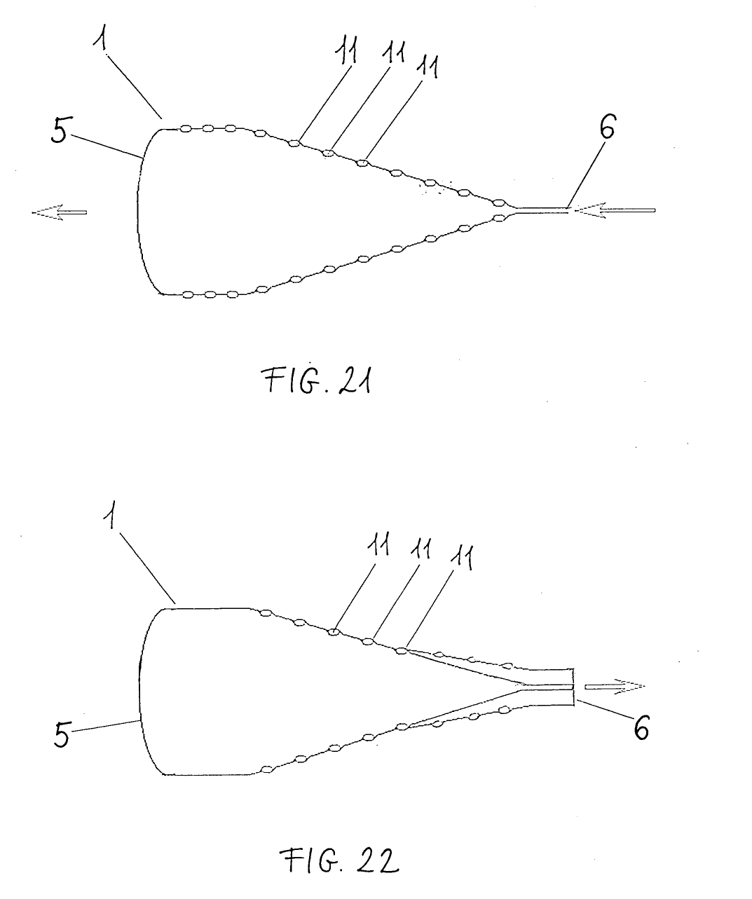

The FIG. 20 shows the realization of the valve according to the invention shown in the FIG. 19, in open position, in semi-view, semi-section.

The FIG. 21 shows a further possible realization of the valve according to the invention, in closed position, in section.

The FIG. 22 shows the realization of the valve according to the invention shown in the FIG. 21, in open position, in section.

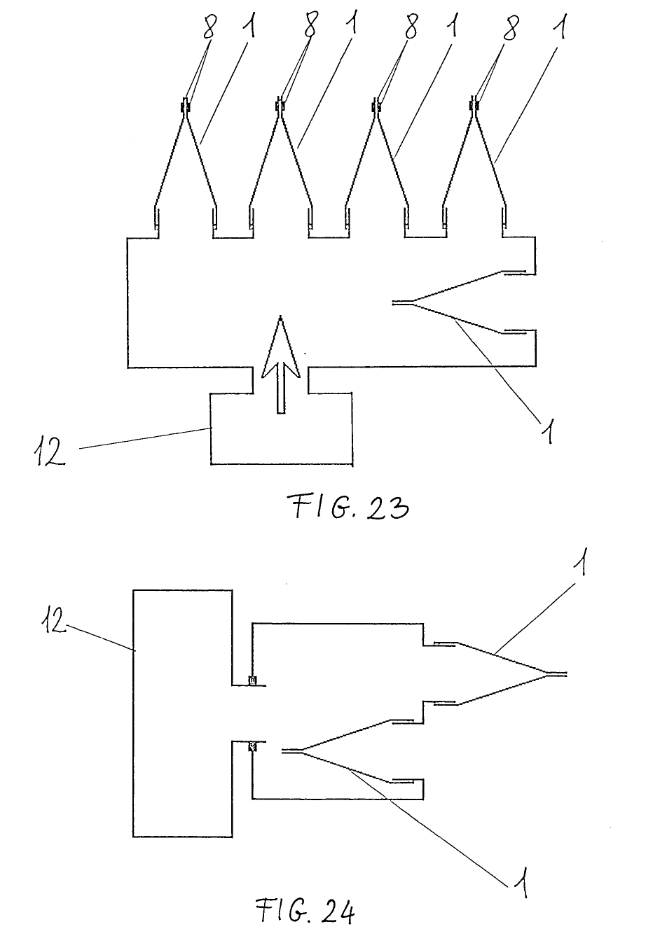

The FIG. 23 shows a possible realization of the combination of valves formed from the valves according to the invention.

The FIG. 24 shows another possible realization of the combination of valves formed from the valves according to the invention.

The FIG. 1 shows a possible realization of the valve according to the invention in closed state, in side view. The Figure shows the basic part 2 of the valve 1 of length H and diameter D with the ingoing opening 5, as well as the intermediate part 3 of length L and the flattened part 4 of length N with the outgoing opening 6. K perimeter contacted with the medium in motion is marked in the Figure. In case of a valve 1 basic part 2 of circle diameter, K=Dπ. In case of a valve 1 basic part 2 of different profile, not a circle D diameter is interpreted virtually, calculated from K perimeter contacted with the medium in motion D=K/π. The proportions of valve 1 are given compared to this real or virtual D value.

The FIG. 2 shows a realization of the valve according to the invention according to the FIG. 1, in top view. The Figure shows the basic part 2 of the valve 1 of length H and diameter D with the ingoing opening 5, as well as the intermediate part 3 of length L and the flattened part 4 of length N and width S with pressed rims 7 and with the outgoing opening 6.

The FIG. 3 shows the realization of the valve according to the invention according to the FIG. 1, from its outgoing opening. In the Figure the valve 1 can be seen with the intermediate part 3 and the outgoing opening 6 of the valve 1, which is in completely closed state this case. It can be seen as well the flattened part 4 of the valve 1 and the pressed rims 7 formed on the flattened part 4.

The FIG. 4 shows the realization of the valve according to the invention according to the FIG. 1, from its ingoing opening. In the Figure we can see the ingoing opening 5 of D diameter of the basic part 2 of the valve 1, as well as its outgoing opening 6, which is closed this case. The flattened part 4 can be seen as well.

The FIG. 5 shows the realization of the valve according to the invention according to the FIG. 1, in slightly open position, in side view. The FIG. 6 shows the realization of the valve according to the invention according to the FIG. 5, from its outgoing opening. The FIG. 7 shows the realization of the valve according to the invention according to the FIG. 5, from its ingoing opening. In the Figures the basic part 2 of the valve 1 of length H and diameter D with the ingoing opening 5, the intermediate part 3 of length L and the flattened part 4 of length N and width S with pressed rims 7 with the outgoing opening 6 can be seen. It can be seen well in the Figures, that this case the outgoing opening 6 is in slightly open position. The flow cross section A2 of the flattened part 4 and the flow cross section A1 of the basic part 2 of the valve 1 in partly open basic state is marked in the Figure.

The FIG. 8 shows the realization of the valve according to the invention according to the FIG. 1, in completely open state, in side view. The FIG. 9 shows the realization of the valve according to the invention according to the FIG. 8, from its ingoing opening. The FIG. 10 shows the realization of the valve according to the invention according to the FIG. 8, from its outgoing opening. In the Figures can be seen the basic part 2 of the valve 1 of length H and diameter D with the ingoing opening 5, the intermediate part 3 of length L and the flattened part 4 of length N and width S formed with pressed rims 7 with the outgoing opening 6. It can be seen well in the Figure, that this case the outgoing opening 6 is in completely open state.

The FIG. 11 shows another possible realization of the valve according to the invention with the magnetic sheets placed on the flattened part, in side view. The FIG. 12 shows the realization of the valve according to the invention according to the FIG. 11, in top view. The FIG. 13 shows the realization of the valve according to the invention according to the FIG. 11, from its outgoing opening 6. In the Figures the formation of the valve 1 according to the invention, shown in FIG. 1 can be seen. This case pairs of magnet plates 8 are placed on the external surface of the opposite sides of the flattened part 4 of the valve 1. Placing of the magnet plates 8 on the flattened part 4 takes place in such a way, that the magnet plates 8 are situated outside the pressed rims 7 of the flattened part 4, at a distance M from them, where 0<M<4V. The magnet plates 8 are placed on one surface at a distance of G from each other, where 0<G<4V. The magnet plates 8 are fixed to the outer surface of the flattened part 4 by known methods, eg. by sticking.

We can use a magnet sheet or magnet block of optional size instead of the magnet plate 8, and we can also apply the method of mixing a material which could be magnetized into the material of the flattened part 4. The quantity of the material that can be magnetized to be mixed into the raw material is max. 60 weight %, preferably 40 weight %. The quantity of the material that can be magnetized to be mixed into the raw material depends on the demand of the extent of magnetizing of the flattened part 4, and it is possible to mix less material that can be magnetized into it, but this quantity is properly magnetized, and it can happen the other way round as well, that is, we put a bigger quantity of the material that can be magnetized into it and magnetize to a lesser extent. The quantity of the material that can be magnetized to be mixed into the raw material depends on the size of the valve 1 and the wall thickness V of the material of the valve 1. Such a solution can be used as well, that a silicone sheet provided with magnet powder is fixed on the flattened part 4 of the base valve 1.

The FIG. 14 shows a further possible realization of the valve according to the invention according to the FIG. 11 in case of the expanded elastic fibre led above the flattened part, in side view. The FIG. 15 shows the realization of the valve according to the invention according to the FIG. 14, in top view. The FIG. 16 shows the realization of the valve according to the invention according to the FIG. 14, from its outgoing opening 6. The FIG. 17 shows the realization of the valve according to the invention according to the FIG. 14, in open position, in side view. The FIG. 18 shows the realization of the valve according to the invention according to the FIG. 14, in open position, from its outgoing opening. In the Figure the formation of the valve 1 shown in the FIG. 11 can be seen as an improvement of the solution, so elastic fibres 9 expanded by pull force F are placed, one above each of the magnet plates 8 situated on the flattened part 4 of the valve 1.

The valve 1 formation shown in the FIG. 1 realizes in itself a slow closing process which is drawn out in time until the leak-proof closing, and this process takes a longer time in practice in most cases, than the closing time permissible by the application. During the use of valve 1 a quicker closing can be ensured with the help of the valve 1 provided with magnet plates 8 shown in the FIG. 11, in such a way, that with the help of the magnet plates 8 the definitely strong closing of the valve 1 can be guaranteed. The magnetic force of the magnet plates 8 exercises a permanent force, acting continuously and so ensures the definite closing process, as during the closing, with the decrease of the distance the magnet plates 8 ensure an increasing closing force. Resulting from the action mechanism of the magnetic force, this solution results in a closing process preliminarily determined as well.

In case the elastic fibres 9 led through above the flattened part 4 of the valve 1 are applied for itself at the valve 1, the closing time of the valve 1 can be decreased by this solution, however this closing time is not appropriate in case of certain applications, because the effect of the elastic fibre 9 decreases continuously at the closing of the valve 1 and it can even go down to zero. It would mean, that in end-position the closing process of valve 1 would be the same as the basic structure shown in the FIG. 1, that is it would be drawn out considerably in time.

With the combination of the magnet plates 8 placed on the flattened part 4 of the valve 1 and that of the elastic fibres 9 led above the magnet plates 8 a valve 1 of proper closing time and definite strong closing can be created. With the joint combination of application of the magnet plates 8 and elastic fibres 9 the closing force can be regulated in such a way, that at the closing of valve 1 the closing forces coming from the tension of the elastic fibre 9 are superposed to the permanent magnetic force of the magnet plates 8. Such a way at the closing of the valve 1 it can be ensured, that elastic fibres 9 expanded properly with pull force F can accelerate the process of magnet plates 8—at first being far from each other, exercising smaller magnetic force on each other,—getting closer to each other earlier, into the distance where they can exercise proper magnetic force and the closing of valve 1 is realized quicker.

The elastic fibre 9 can be of profile form, eg. closing cams can be placed on it, or the elastic fibre 9 itself can be of different diameter. These solutions can result in different values both in case of the closing force and the stretching force.

The FIG. 19 shows a further possible realization of the valve according to the invention, in closed position, in semi-view, semi-section. The FIG. 20 shows the realization of the valve according to the invention shown in the FIG. 19, in open position, in semi-view, semi-section. In the Figure the formation of valve 1 according to the FIG. 1 can be seen. This case flow gaps 10 are formed in the intermediate part 3 of the valve 1. This solution is applied in that case, when we need faster outflow and slower back flow. This solution allows a much faster outflow, as the medium in motion goes out of the given space not only through the outgoing opening 6, but through the flow gaps 10 as well. At the same time the valve 1 ensures in its closed position as well, that air can flow in or out to a small extent through the flow gaps 10, so the space to be closed is in permanent contact with the outside space through the flow gaps 10, eg. in case of the airing of the inside space. The flow gaps 10 allow a flow in both ways. At the same time in case of a big change of pressure the valve also opens, ensuring so the balance of pressure to be achieved. The great advantage of the construction is, that different flow values can be chosen for each direction. The size of the flow gaps 10 is adjusted to the given application.

The FIG. 21 shows a further possible realization of the valve according to the invention, in closed position, in section. The FIG. 22 shows the realization of the valve according to the invention shown in the FIG. 21, in open position, in section. In the Figure a formation of the valve 1 is shown, where the material of the valve is of a material provided with pores 11. The material of the valve is eg. a fabric of dense weaving, semi-permeable material. In case of applying this solution the result is similar to the solution shown in the FIG. 19, if an appropriately elastic fabric is used for the realization of the valve 1.

The FIG. 23 shows a possible realization of the combination of valves formed from the valves according to the invention. This valve combination is the combination of a pressure relief of several stages and that of a feeding valve. In the Figure the regulated space 12 can be seen with the valve combination formed from the valves 1 joining it. The given valve combination this case consists of five pieces of valves 1 out of which four valves 1 are placed in such a way, that they can ensure outflow of the medium in motion from the regulated space 12 with the help of their outgoing openings 6 in such a way, that each valves 1 are set to different opening pressures, that is they open at the effect of different pressure differences. The function of the valves 1 working at different opening pressure can be set with the help of a mechanics (excenter). Such a way the mechanics always lets the valve in use function. The function of the fifth valve 1 of the valve combination is to ensure the back flow of the medium in motion flown out. The advantage of this combination of valves is, that different pressure conditions can be created without regulating the valves separately. Accordingly four non-adjustable, different fix pressure condition can be created. At the same time there is no possibility of continuous adjusting with this solution.

The FIG. 24 shows another possible realization of the combination of valves formed from the valves according to the invention. In the Figure the regulated space 12 can be seen, as well as the valves 1, out of which one ensures the emptying of the outflowing medium in motion from the regulated space 12, whereas the other valve 1 ensures its back flow to the regulated space 12. This solution is the realization of the classical 3/2 valve with the help of the valves 1 according to the invention, in which case the opening pressure of the valve 1 ensuring the outflow is preferably higher, than that of the other valve 1 providing feeding.

In case of a preferable realization of the solution according to the invention as a first step a tube-tract made of soft, elastic material, primarily of silicon of diameter D and length H is created. Following this, two opposite points of the diameter D chosen optionally in the arc at one end of the tube-section are marked. From both marked points S-S distance is measured into both direction on the arc, and this end of the tube-section is flattened in such a way, that this end of the tube-section creates a straight line between the two marked points, that is the semi-arc parts of the arc halved by the two points are situated directly above each other. Following this, the—this case straight—semi-arc passages situated above each other are fixed airtight to each other in S-S radial distance along the length of the arc and N-N axial distance along the length H of the tube-section, forming this way the pressed rim 7 and the intermediate part 3 between the pressed rim 7 and the basic part 2 creating this way the valve 1 according to the invention.

In case of a preferable realization of the solution according to the invention in case of application of the valve 1 a great yield of flow (1-8 l/sec) is realized. It is characteristic of the way of application, that in case in basic position (with zero flow) the valve 1 is open, in case of relatively small pressure differences (0-5 kPa) it can be achieved with the harmonization of the characteristics, that in the initial part of the back flow, resulting from the inner pressure of the tube and from the greater pressure effecting the wall from outside, the valve closes strongly and keeps this closing position ensuring great compactness.

In case of a preferable realization of the valve 1 according to the invention it can be achieved with the size of the cross-section conforming with the order of volume of the air-flow going through, that time for regulating the emptying and feeding of spaces is long enough. The valve 1 changes its cross-section depending on the rate of the pressure difference and the flow.

In case of a preferable, formation the mechanical structure of the valve 1 is made of a tube of circular cross-section in such a way, that one end of the tube is flattened. Resulting from the flexible property of the material, a natural conicity occurs, which is not influenced by another way.

It is characteristic of the size proportions, that the wall thickness of the tube, taking into consideration the flexible properties of the material, should be suitable for forming a self-bearing flattened tube-section, so it should not collapse. The cross-section created beside ensuring the required flow yields, should make laminar flow possible. The size of the outer surface of the flattened part considerably influences the rate of the closing delay in the check valve function. When used as a check valve the valve is open in basic position, but it can be closed as well, but the closed state is eliminated by the pressure difference caused by the inflow. The surface of the flattened part should be big enough to realize the closing function.

In case of a preferable, realization of the valve according to the invention certain phases of the polymerization of silicone is used to achieve the form suitable for our purpose. Resulting from this the tube can be permanently flattened for the purpose of check valve, and this flattened state should be made final. This solution can be used for the formation of an bleeding valve too.

In case of using it as a pressure relief valve, the closed position in basic state can be ensured by an auxiliary force, for example by a magnet, a flexible fibre, gravity or spring force. With the adjustment of this auxiliary force it can be achieved, that the valve closes at a definite pressure difference. The opening pressure difference is determined compared to this by the rate of hysteresis.

The valve in basic formation according to the invention already has a basic function, the function of the check valve, and this basic formation is formed or modified in special ways to meet the demand of further preferable applications. The new structural form described here makes possible, that the basic structure in basic state is open, but in case of opposite direction flow it automatically closes granting proper compact closing.

It means, that in the basic state in the check valve there is free flow of the medium in one direction. Among the inventions mentioned above there was no such case. The new structural form described here by unmakes possible, that the basic structure is open in basic state, but in case of an opposite direction flow it automatically closes granting proper compact closing.

If the valve 1 is mechanically open in the basic position, then the pressure differences of its in-and output can be balanced without loss with extremely low flow values in both directions, this way the airing of the space to be fed or regulated can be solved. At the same time in case of opposite direction flow the valve 1 closes properly even in case of very little flow. This can be realized because the flow cross-section and the properties of the material, thickness and material components are chosen this way.

The advantages of the solution according to the invention and fields of application: It is inexpensive, simple, easy to produce, of long-life, the basic structure does not contain mobile part, the valve itself ensures the closing function, accuracy of repetition is high, ensures leak-proof closing. It can be produced from one piece, it can be produced by using the known industrial technologies and materials.

The valve according to the invention ensures relative definitely large air-flow in the opening direction, whereas in the closing direction it ensures closing of low hysteresis, besides it makes possible proper compact closing even in case of small pressure difference.

The valve according to the invention can balance the low flow values resulting from small pressure differences in basic position, but in case of sudden changes of pressure, or at the effect of flows of great speed it closes.

Fields of application:
for air-beds, air-cushions, comfort-cushions of foam filling,
limiting the over-pressure of closed spaces, or keeping this over-pressure,
ensuring one-way flow of gases, fluid mediums,
for realizing large flow cross-section in one direction and limited flow cross-section in the other direction.

### LIST OF REFERENCES

1—valve
2—basic part
3—intermediate part
4—flattened part
5—ingoing opening
6—outgoing opening
7—pressed rim
8—magnet plate
9—elastic fibre
10—flow gap
11—pore
12—regulated space
D—tube diameter
V—wall thickness
H—tube length
N—length of flattened part
L—length of narrowing part
S—width of flattened part
G—distance
K—perimeter
M—distance
A1—flow cross-section (basic part)
A2—flow cross-section (flattened part)
F—pull force

1. A valve (1), which is made in one piece from a soft, flexible material, and has a full cross-sectional open basic part (2) at one end, and an intermediate part (3) of decreasing cross-section joining the said basic part (2), and a flattened part (4) joining the intermediate part (3) in the other end of the valve (1), wherein
the flattened part (4) is a structure sintered or pressed or glued in the material of the valve (1), and on the flattened part (4) of the valve (1) a pressed rim (7) is formed by airtight fixing of the edges of the flattened part (4), optionally by sintering, or pressing or glueing,
furthermore the length (L) of the intermediate part (3) is L=0.5 to 6 (K/π), compared to perimeter (K) of the basic part of the valve (1),
and the length (N) of the pressed rim (7) of the basic part of the valve (1) compared to perimeter (K) is N=0.1 to 2 (K/π).

2. A valve according to claim 1, wherein the shape of the open basic part (2) of the valve (1) is circular, oval, or angular, optionally triangular, square, polygonal, optionally hexagonal, or octagonal.

3. A valve according to claim 1, wherein the flattened part (4) is closed, or partly open in a basic state of the valve (1).

4. A valve according to claim 1, wherein for influencing the closing of valve (1) magnetizable metal plates or magnet plates (8) are placed on the flattened part (4) of the valve (1), and/or the material of the flattened part (4) can be magnetized by casting, pressing or mixing metal powder or magnetic powder into said material of the flattened part.

5. A valve according to claim 1, wherein for influencing the closing of the valve (1) one or more expanded elastic fibres (9) are symmetrically, or asymmetrically placed above the flattened part (4) of the valve (1).

6. A valve according to claim 1, wherein the material of said valve (1) is of closed surface, optionally natural or artificial rubber, optionally silicone rubber, or textile or paper, impregnated or surface-treated by a natural or artificial rubber, optionally silicone rubber, and the thickness (V) of the material of the valve (1) compared to the perimeter (K) in the basic part of the valve (1) is V=0.01 to 0.2 (K/π).

7. A valve according to claim 1, wherein the material of the valve (1) is porous material, optionally textile or paper and the rate of porousness is 2 to 40% compared to the free outflow over the same amount of surface area.

8. A valve according to claim 1, wherein the intermediate part (3) of the valve (1) is provided with flow gaps (10).

9. A valve according to claim 1, the valve (1) in basic state is partly open, and the flow cross-section (A2) of the flattened part (4) in basic state is 1 to 66% of the flow cross-section (A1) of the basic part (2).

10. A valve according to claim 1, wherein the width (S) of the pressed rim (7) compared to the perimeter (K) in the basic part (2) of the valve (1) is S=0.04 to 0.42 (K/π).

11. A valve according to claim 1, wherein the valve (1) is provided with a filter at its ingoing opening (5) and/or at its outgoing opening (6).

12. A valve according to claim 1, wherein the regulation of the closing of the valve (1) takes place by the changing of a magnetic force.
